(19) United States
(12) Patent Application Publication
(10) Pub. No.: US 2023/0410048 A1
(43) Pub. Date: Dec. 21, 2023

(54) INFORMATION PROCESSING DEVICE, INFORMATION PROCESSING METHOD, AND RECORDING MEDIUM

(71) Applicant: NEC Corporation, Tokyo (JP)

(72) Inventors: Kei Shibuya, Tokyo (JP); Zhenwei WANG, Tokyo (JP); Kenichiro FUKUSHI, Tokyo (JP); Masanori TSUJIKAWA, Tokyo (JP)

(73) Assignee: NEC Corporation, Tokyo (JP)

(21) Appl. No.: 18/207,529

(22) Filed: Jun. 8, 2023

(30) Foreign Application Priority Data
Jun. 16, 2022 (JP) 2022-096964

(51) Int. Cl. G06Q 10/10

(52) U.S. Cl. CPC G06Q 10/103

(57) ABSTRACT

In the information processing device, the information acquisition means acquires project information inputted by an R&D worker. The information output means outputs the project information to a user terminal. The project application acquisition means acquires applications for a project inputted by a plurality of user terminals. The project establishment determination means determines whether or not the project is established, based on the applications for the project.

### TECHNICAL FIELD

The present disclosure relates to a platform for data collection.

### BACKGROUND ART

Recently, research and development related to health care for maintaining and promoting the health of mind and body is popular worldwide. For such healthcare-related research and development, data provided by the research subject persons are indispensable. For example, in development of healthcare-related applications, if sufficient data cannot be continuously collected from research subject persons, application development may be discontinued and the development costs may be wasted. Patent Document 1 proposes a mechanism capable of efficiently collecting clinical data, wherein clinical researchers prepare explanatory materials to be used for informed consents and doctors cooperate in providing the clinical data in exchange for the explanatory materials.
Patent Document 1: Japanese Patent Application Laid-Open under No. 2005-215923

However, even by Patent Document 1, it is not always possible to sufficiently collect data of the research subject persons.

### SUMMARY

It is one object of the present disclosure to provide an information processing device capable of collecting sufficient data from research subject persons in research and development related to healthcare.

According to an example aspect of the present invention, there is provided an information processing device comprising:

an information acquisition means configured to acquire project information inputted by an R&D worker;

an information output means configured to output the project information to a user terminal;

a project application acquisition means configured to acquire applications for a project inputted by a plurality of user terminals; and

a project establishment determination means configured to determine whether or not the project is established, based on the applications for the project.

According to another example aspect of the present invention, there is

provided an information processing method comprising:

acquiring project information inputted by an R&D worker;

outputting the project information to a user terminal;

acquiring applications for a project inputted by a plurality of user terminals; and

determining whether or not the project is established, based on the applications for the project.

According to still another example aspect of the present invention, there is provided a recording medium recording a program, the program causing a computer to:

acquire project information inputted by an R&D worker;

output the project information to a user terminal;

acquire applications for a project inputted by a plurality of user terminals; and

determine whether or not the project is established, based on the applications for the project.

According to the present disclosure, it will be possible to collect sufficient data from research subject persons in healthcare-related research and development.

### BRIEF DESCRIPTION OF THE DRAWINGS

FIG. 1 is an overall configuration of a data collection system according to a first example embodiment.

FIG. 2 is a block diagram showing a configuration of a server.

FIG. 3A is a block diagram showing a configuration of a user terminal.

FIG. 3B is a block diagram showing a research and development terminal.

FIG. 4 is a block diagram showing a functional configuration of the server, the user terminal, and the research and the development terminal.

FIG. 5 is an example of data structure of a user DB.

FIG. 6 is an example of data structure of a project DB.

FIG. 7 is an example of data structure of a completed service DB.

FIG. 8 is a flowchart of the data collection system.

FIG. 9 is a block diagram showing a functional configuration of an information processing device of a second example embodiment.

FIG. 10 is a flowchart of processing by the information processing device of the second example embodiment.

### EXAMPLE EMBODIMENTS

### First Example Embodiment

[System Configuration]

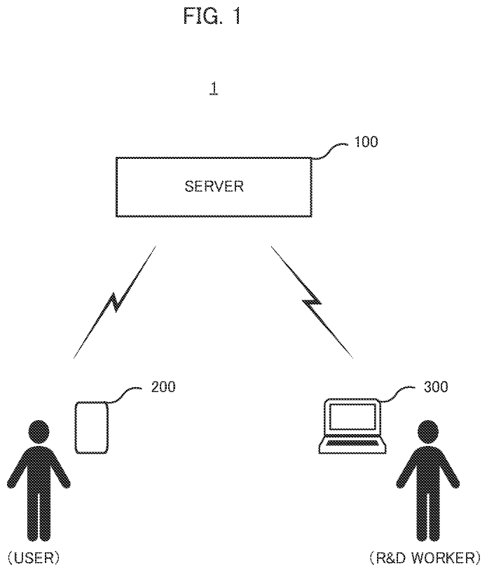

FIG. 1 shows an overall configuration of a data collection system to which an information processing device according to the present disclosure is applied. The data collection system 1 includes a server 100, a user terminal 200 used by a research subject person (hereinafter also referred to as a “user”), and a research and development (hereinafter also referred to as “R&D”) terminal 300 used by an R&D worker. The server 100 is an example of an information processing device. The server 100 and the user terminal 200 can communicate wirelessly with each other, and the server 100 and the R&D terminal 300 can communicate wirelessly.

While one user terminal 200 and one R&D terminal 300 are shown in FIG. 1, multiple user terminals 200 and multiple R&D terminals 300 may exist, respectively. In addition, it is assumed that the users and the R&D workers have agreed with the user policy of the data collection system 1 in advance.

As a basic operation, the server 100 mediates between a user who wants to provide his or her own data and an R&D worker who wants to collect the data by communicating with the user terminal 200 and the R&D terminal 300. Specifically, the R&D worker launches a project to develop a healthcare-related application. In order to collect data, the R&D worker registers information about the project (hereinafter, also referred to as “project information”) with the server 100 via the R&D terminal 300 and recruits project participants. The project information includes contents of the project, data to be collected, a number of applicants, participation conditions, an application period, etc.

The user registers information about the user (hereinafter also referred to as “user information”) in advance with the server 100 through the user terminal 200. Then, the user obtains a list of the projects that are recruiting participants from the server 100 via the user terminal 200 at an arbitrary timing. If the user finds a project that the user wants to participate in the list of the projects, the user transmits an application for the project to the server 100 via the user terminal 200.

The server 100 accepts the user's application if the user satisfies the participation conditions of the project. The server 100 determines whether or not the project has been established based on the number of recruited persons and the number of applicants.

If the number of the applicants for the project reaches the number of recruited persons, the server 100 determines that the project is established. When the project is established, the R&D worker can collect data from the users. Incidentally, the server 100 may give an incentive to the users when the project is established. For example, the incentive is a point that can be used on the data collection system 1, and the user can exchange the points with a pay application or the like. The number of points to be given and the timing of giving the points may be arbitrarily set by the R&D worker for each project. The R&D workers may set to give the incentives collectively when the project is established, or may set to give the incentives step by step during the development periods for the application. By giving the incentives step by step, the R&D worker can continuously collect data from the users.

On the other hand, when the number of the applicants does not reach the number of the recruited persons even after the recruiting period has elapsed, the server 100 determines that the project is not been established. At this time, the R&D workers may review the number of recruited persons, the participation conditions, the incentives and the like, and recruit the participants again. Instead, the R&D workers may stop the project. The R&D workers can grasp the expectation level of the users for the project from the number of applicants who wanted to participate in the project, and judge whether the project should be continued or stopped.

[Server]

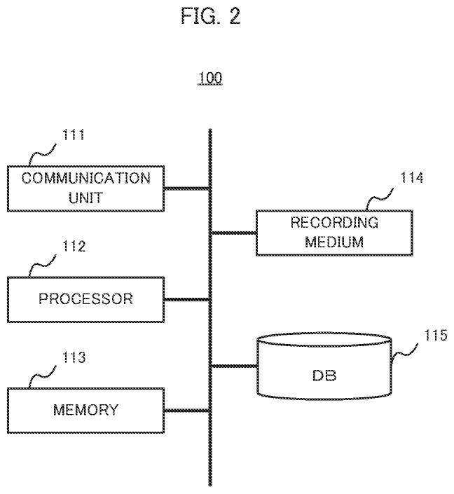

FIG. 2 is a block diagram showing a configuration of the server 100. The server 100 mainly includes a communication unit 111, a processor 112, a memory 113, a recording medium 114, and a data base (DB) 115.

The communication unit 111 transmits and receives data to and from an external device. Specifically, the communication unit 111 transmits and receives information to and from the user terminal 200 and the R&D terminal 300.

The processor 112 is a computer, such as a CPU (Central Processing Unit), that controls the server 100 in its entirety by executing a predetermined program. The processor 112 may be a GPU (Graphics Processing Unit), a FPGA (Field-Programmable Gate Array), a DSP (Demand-Side Platform), an ASIC (Application Specific Integrated Circuit), or the like.

The memory 113 may be configured by a ROM (Read Only Memory), a RAM (Random Access Memory), and the like. The memory 113 stores various programs executed by the processor 112. The memory 113 is also used as a working memory during various processing operations by the processor 112.

The recording medium 114 is a non-volatile and non-transitory recording medium such as a disk-like recording medium or a semiconductor memory, and is configured to be detachable from the server 100. The recording medium 114 records various programs executed by the processor 112.

The database (DB) 115 stores the project information, the user information, etc. The DB 115 may include an external storage device, such as a hard disk, coupled to or installed in the server 100, and may include a storage medium, such as a removable flash memory. Instead of providing the DB 115 in the server 100, the DB 115 may be provided in an external server or the like, and the project information and the user information may be stored into the server through communication.

The server 100 may include an input unit such as a keyboard and a mouse, and a display unit such as a liquid crystal display, thereby to allow an administrator to give instructions or input.

[User Terminal]

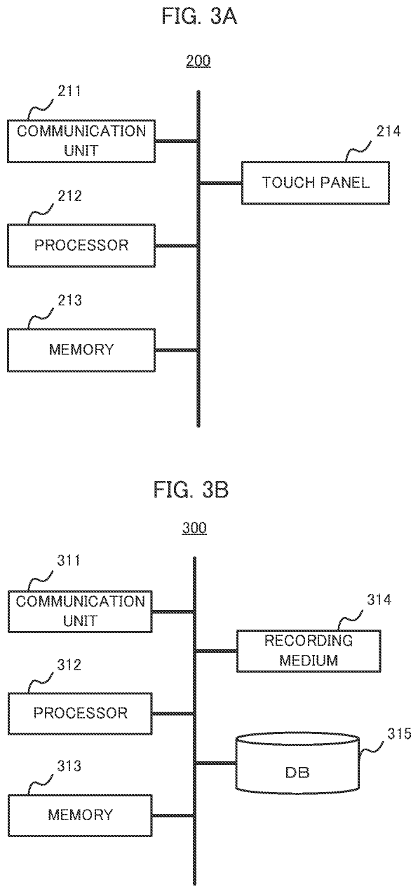

FIG. 3A is a block diagram illustrating an internal configuration of the user terminal 200. The user terminal 200 is, for example, a terminal device such as a smartphone, a tablet, or a PC (Personal Computer). The user terminal 200 includes a communication unit 211, a processor 212, a memory 213, and a touch panel 214.

The communication unit 211 transmits and receives data to and from an external device. Specifically, the communication unit 211 transmits and receives information to and from the server 100.

The processor 212 is a computer such as a CPU, and controls the user terminal 200 in its entirety by executing a program prepared in advance. The processor 212 may be a GPU, an FPGA, a DSP, an ASIC or the like.

The memory 213 is configured by a ROM, RAM, or the like. The memory 213 stores various programs executed by the processor 212. The memory 213 is also used as a working memory during various processing operations by the processor 212.

The touch panel 214 displays information received by the user terminal 200. The touch panel 214 also functions as an input device of a user.

The user terminal 200 may include a camera or a sensor to acquire data to be provided to the R&D worker.

[R&D Terminal]

FIG. 3B is a block diagram showing a configuration of the R&D terminal 300. The R&D terminals is a terminal device such as a tablet or a PC, for example. The R&D terminal 300 mainly includes a communication unit 311, a processor 312, a memory 313, a recording medium 314, and a data base (DB) 315.

The communication unit 311 transmits and receives data to and from an external device. Specifically, the communication unit 311 transmits and receives information to and from the server 100.

The processor 312 is a computer, such as a CPU, and controls the R&D terminal 300 in its entirety by executing a program prepared in advance. The processor 312 may be a GPU, an FPGA, a DSP, an ASIC or the like.

The memory 313 is configured by a ROM, a RAM, or the like. The memory 313 is also used as a working memory during various processing operations by the processor 312.

The recording medium 314 is a non-volatile and non-transitory recording medium such as a disk-like recording medium or a semiconductor memory, and is configured to be detachable from the R&D terminal 300. The recording medium 314 records various programs executed by the processor 312.

The databases (DB) 315 store the project information. The DB 315 may include an external storage device, such as a hard disk, coupled to or installed in the R&D terminal 300, or may include a storage medium such as a removable flash memory. Instead of providing the DB 315 in the R&D terminal 300, the DB 315 may be provided in an external server or the like to store the project information into the server 100 by communication.

The R&D terminal 300 may include an input unit such as a keyboard and a mouse, and a display unit such as a liquid crystal display, thereby to allow an administrator to give instructions and inputs.

[Functional Configuration]

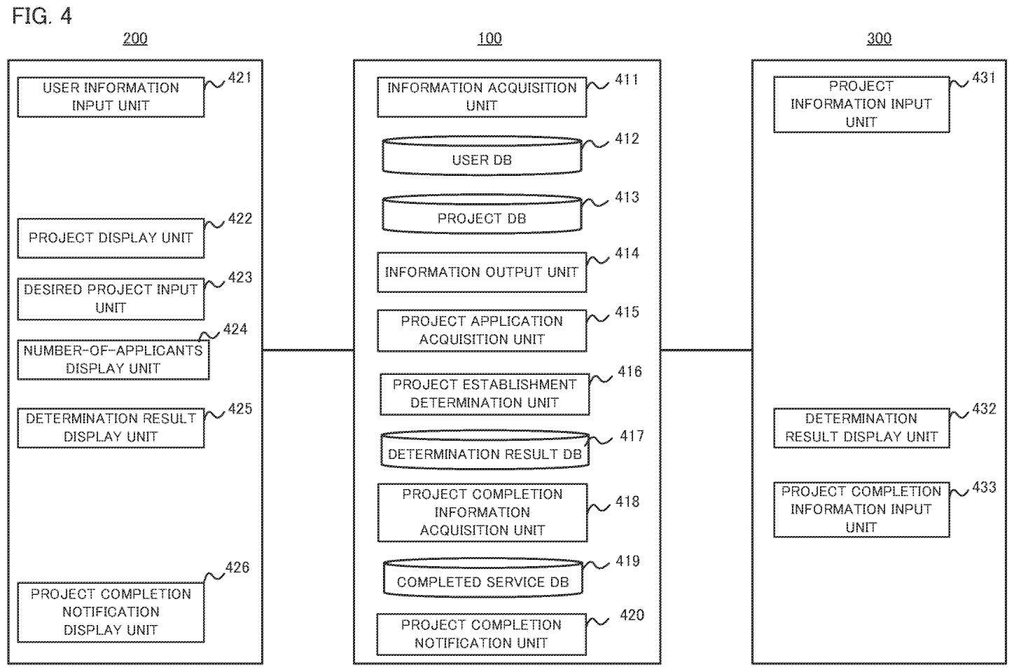

FIG. 4 is a block diagram showing a functional configuration of the server 100, the user terminal 200, and the R&D terminal 300.

The server 100 functionally includes an information acquisition unit 411, a user DB 412, a project DB 413, an information output unit 414, a project application acquisition unit 415, a project establishment determination unit 416, a determination result DB 417, a project completion information acquisition unit 418, a completed service DB 419, and a project completion notification unit 420.

The user terminal 200 functionally includes a user information input unit 421, a project display unit 422, a desired project input unit 423, a number-of-applicants display unit 424, a determination result display unit 425, and a project completion notification display unit 426. Further, the R&D terminal 300 functionally includes a project information input unit 431, a determination result display unit 432, and a project completion information input unit 433.

The user information input unit 421 of the user terminal 200 acquires the user information inputted by the user to the user terminal 200, and transmits the information to the server 100. The project information input unit 431 of the R&D terminal 300 acquires the project information inputted by the R&D worker to the R&D terminal 300, and transmits the acquired project information to the server 100. The information acquisition unit 411 of the server 100 stores the user information received from the user terminal 200 in the user DB 412 in association with the user's identification information. Also, the information acquisition unit 411 of the server 100 stores the project information received from the R&D terminal 300 in the project DB 413 in association with the identification information of the project.

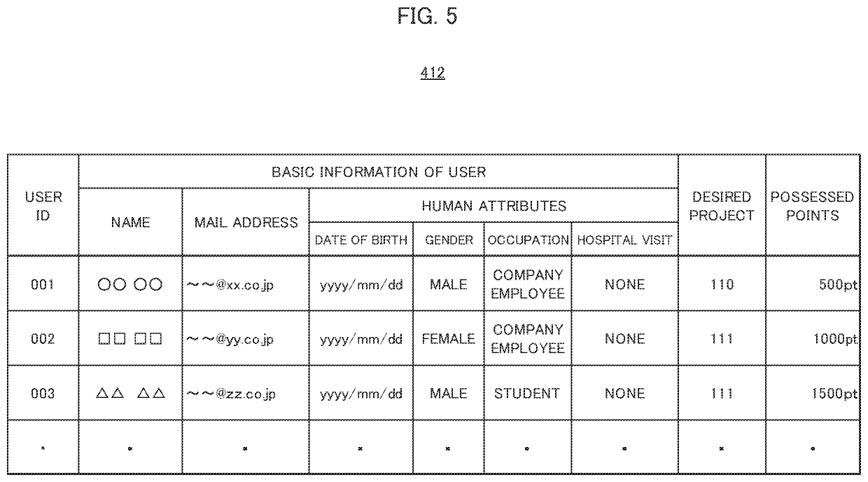

Here, the user information and the project information will be explained with examples. FIG. 5 illustrates an example of data structure of the user information. In this example, the user ID and the user information are associated and stored in the user DB 412. The user ID is a number for uniquely identifying a user. The user information includes the basic information of the user, the desired project that the user wants to participate, and the possessed points. The basic information of the user is information registered in advance by the user to the server 100, and includes the name, the mail address, and the human attributes of the user. The human attributes include, for example, the attribute information of the user such as the date of birth, the gender, the occupation, and the history of hospital visit of the user. The desired project is the identification information of the project that the user wants to participate in at the present moment, and the project ID described later is stored in FIG. 5. The possessed point is the number of points that the user currently has. The user can acquire points as incentives by participating in the project.

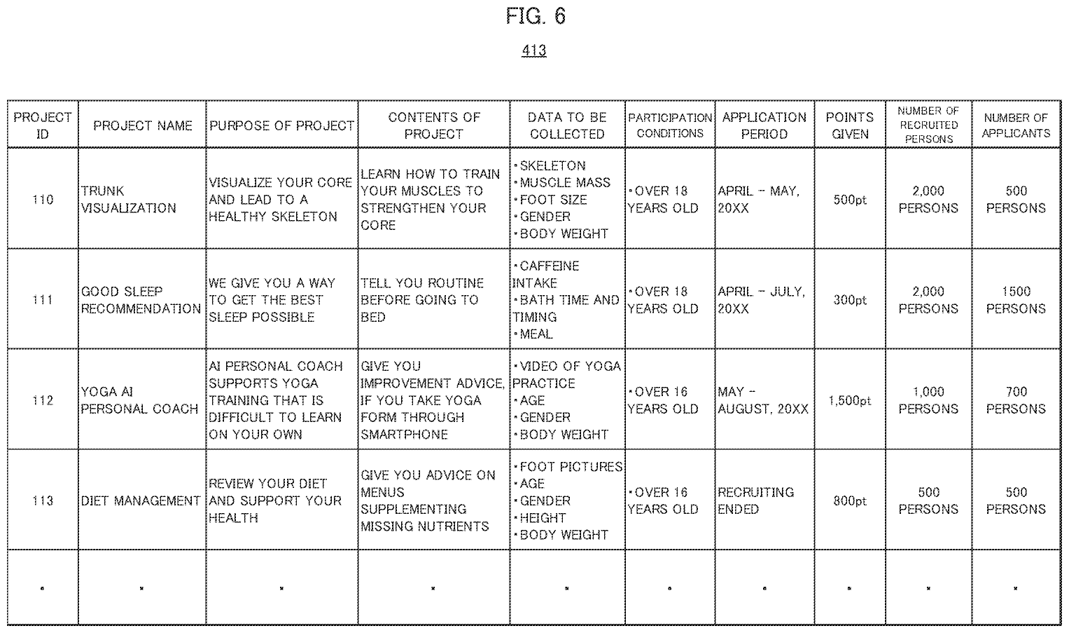

FIG. 6 shows an example of data structure of the project information. In this example, the project ID is associated with the project information and is stored in the project DB 413. The project ID is a number that uniquely identifies a project. The project information includes the project name, the purpose of the project, the contents of the project, the data to be collected, the participation conditions, the application period, the points given, the number of recruited persons, and the number of applicants. The data to be collected indicates the type of data that the R&D worker wants to collect from the users. In addition, the participation conditions are the conditions of the user who can participate in the project. The R&D worker can set the human attributes such as “age”, “occupation”, and “history of hospital visit” as the participation conditions, for example. The number of applicants is the total number of the users currently applying for the project. The number of applicants is updated when the server 100 accepts an application or a cancellation by the user, for example.

Returning to FIG. 4, the information output unit 414 of the server 100 extracts the project information of the project that satisfies the predetermined conditions from the project DB 413, and generates a list of the projects. An example of the predetermined condition is that the project is within the application period. The information output unit 414 transmits the generated list of the projects to the user terminal 200.

The user terminal 200 receives the list of the projects from the server 100. The project display unit 422 of the user terminal 200 displays the list of the projects on the screen of the user terminal 200. When the user operates desired project input unit 423 of the user terminal 200 and selects the project that the user wants to participate (hereinafter referred to as the “desired project”) from the list of the projects, the desired project input unit 423 of the user terminal 200 transmits the project ID of the desired project selected by the user to the server 100 together with the user ID.

The project application acquisition unit 415 of the server 100 receives the project ID of the desired project and the user ID from the user terminal 200, and outputs them to the project establishment determination unit 416 of the server 100.

The project establishment determination unit 416 of the server 100 acquires the project ID of the desired project and the user ID from the project application acquisition unit 415. Then, the project establishment determination unit 416 determines whether or not the user satisfies the participation conditions of the project. Specifically, the project establishment determination unit 416 extracts the participation conditions of the objective project from the project DB 413 based on the project ID of the desired project. Also, the project establishment determination unit 416 extracts the user information of the objective user from the user DB 412 based on the user ID. Then, the project establishment determination unit 416 compares the user information with the participation conditions of the project and determines whether or not the user satisfies the participation conditions of the project. If the user satisfies the project participation conditions, the project establishment determination unit 416 accepts the user's application and updates the number of applicants in the project DB 413. If the user does not satisfy the participation conditions of the project, the project establishment determination unit 416 may send, to the user terminal 200, a notification indicating that the user does not satisfy the participation conditions of the project.

The project establishment determination unit 416 determines whether or not the project is established at a predetermined timing, and outputs the determination result to the determination result DB 417. The establishment status of project such as “Established,” “Not established,” and “Under determination” is stored in the determination result DB 417 for each project ID. The predetermined timing is, for example, a timing at which the project establishment determination unit 416 updates the number of applicants in the project DB 413 or a timing at which the application period has elapsed.

Specifically, the project establishment determination unit 416 determines whether or not the project is established on the basis of the number of recruited persons and the number of applicants of the project. The project establishment determination unit 416 extracts the number of applicants and the number of recruited persons of the project from the project DB 413 at the predetermined timing. Then, the project establishment determination unit 416 determines that the objective project is established when the number of applicants of the project reaches the number of recruited persons, and outputs the determination result of “Established” to the determination result DB 417. In addition, the project establishment determination unit 416 ends the recruitment for the established projects by, for example, updating the application period in the project DB 413 to “Recruitment ended.” The project establishment judgment unit 416 transmits the project established notification to the user terminal 200 and the R&D terminal 300 in order to notify the user and the R&D worker that the project is established. At this time, the project establishment determination unit 416 may send the project established notification to the user terminal 200 including the guidance for the user. The guidance for the user may include, for example, how to upload the data to be collected, or how to download the application under development. When the project is established, the project establishment determination unit 416 gives some points to the user as an incentive. The project establishment determination unit 416 adds the predetermined number of points to the possessed points in the user DB 412 for the objective user.

On the other hand, if the number of applicants for the project does not reach the number of recruited persons, the project establishment determination unit 416 determines that the target project is under determination and outputs the determination result of “Under determination” to the determination result DB 417. Further, if the number of applicants for the project does not reach the number of recruited persons even when the application period has elapsed, the project establishment determination unit 416 determines that the target project is not satisfied, and outputs the determination result of “Not established” to the determination result DB 417. Then, the project establishment judgment unit 416 transmits the project unestablsihed notification to the user terminal 200 and the R&D terminal 300 in order to notify the user and the R&D worker that the project was not established. At this time, the project establishment determination unit 416 may send the project unestablished notification including the information of other recommended projects to the user terminal 200. The recommended projects may include other projects similar to the project that user has applied for, and other projects that are determined based on the history of the project that user has applied for in the past. For example, when the “Trunk visualization project” for which the user has applied is not established, the project establishment determination unit 416 may include a “Yoga AI Personal Coach Project” which can train the trunk as a recommended project in the project unestablished notification, and transmits the project unestablished notification to the user terminal 200.

The user terminal 200 receives the project established notification or the project unestablished notification from the server 100. The determination result display unit 425 of the user terminal 200 displays the contents of the notification on the screen of the user terminal 200. Also, the R&D terminal 300 receives the project established notification or the project unestablished notification from the server 100. Then, the determination result display unit 432 of the R&D terminal 300 displays the contents of the notification on the screen of the R&D terminal 300. By this, the users and the R&D workers can know whether or not the project is established.

After receiving the project established notification, the R/D worker may collect data from the user via the server 100 or directly from the user without going through the server 100. For example, when collection of biological samples is required or when exchanging papers is required, the R&D worker may collect data directly from the user, not through the server 100.

It is noted that the user can check the number of applicants for his or her desired project during its recruiting period. When the user requests the server 100 to inquire about the number of applicants for the desired project through the user terminal 200, the information output unit 414 of the server 100 extracts the number of recruited persons and the number of applicants of the desired project from the project information stored in the project DB 413. Then, the information output unit 414 transmits the number of recruited persons and the number of applicants of the desired project to the user terminal 200. The number-of-applicants display unit 424 displays, on the screen of the user terminal 200, the number of recruited persons and the number of applicants of the desired project received from the server 100. For example, the number-of-applicants display unit 424 displays a message such as “The recruited number of the project XX is 1000 persons. The number of applicants is 700 persons. The project will be established by additional 300 applicants.” on the screen of the user terminal 200. This allows the user to check the number of applicants for his or her desired project. In addition, the user can change the desired project if the number of applicants is small and the project is not expected to be established.

The R&D worker inputs the project completion information to the R&D terminal 300 when a service such as an application is completed (i.e., the project is successful) or when the project is discontinued halfway (i.e., the project is failed). The project completion information input unit 433 of the R&D terminal 300 acquires the project completion information inputted by the R&D worker and transmits it to the server 100. The project completion information includes the project ID of the completed project, whether the project is established or not, the completed service information, and the project termination report, etc. The completed service information is inputted to the R&D terminal 300 by the R&D worker if the project is established. The completed service information includes the completed services and detailed descriptions such as the name, the contents and the selling price of the completed service. The project termination report indicates the reason why the project was terminated, and is inputted to the R&D terminal 300 by the R&D person when the project is failed.

The project completion information acquisition unit 418 of the server 100 receives the project completion information from the R&D terminal 300. The project completion information acquisition unit 418 outputs the project completion information to the project completion notification unit 420 of the server 100. Also, when the project completion information includes the completed service information, the project completion information acquisition unit 418 stores the completed service information in the completed service DB 419. The services stored in the completed service DB 419 are published and sold on the data collection system 1.

The project completion notification unit 420 generates a project completion notification based on the project completion information acquired from the project completion information acquisition unit 418. Then, the project completion notification unit 420 transmits the project completion notification to the user terminal 200. The project completion notification includes information on whether the project was successful or not. If the project was successful, the project completion notification unit 420 may include a usage procedure of the completed service or the like in the project completion notification. If the project was failed, the project completion notification unit 420 may include a recommended project or the like in the project completion notification. The server 100 may take over the data provided by the user in the failed project to the recommended project, if the data provided in the failed project is the same as the data of the recommended project.

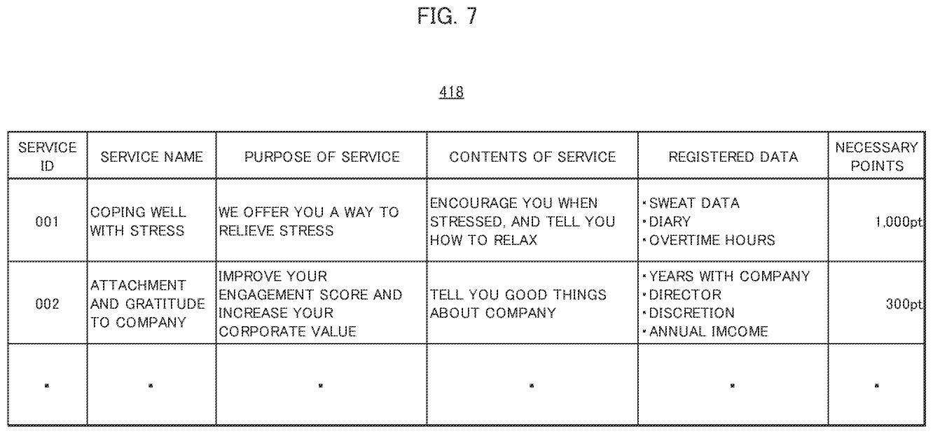

FIG. 7 shows an example of a data structure of the completed service information. In this example, the service ID and the completed service information are associated with each other and are stored in the completed service DB 419. The service ID is a number for uniquely identifying a service. The completed service information includes the service name, the purpose of the service, the contents of the service, the registered data, the number of necessary points, etc. The registered data includes the user information required to use the service and the user information that can be recorded and managed on the service. The number of necessary points is the number of points required to purchase the service. The users can buy services using their own possessed points.

[Determination Processing]

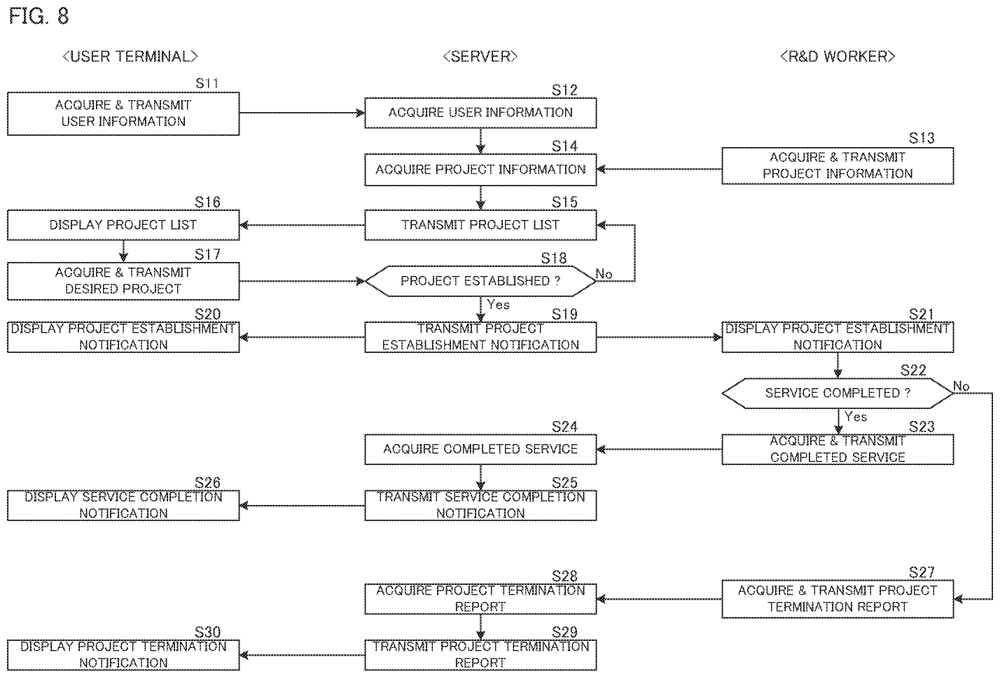

Next, information processing to execute the above-described determination processing will be described. FIG. 8 is a flowchart of determination processing executed by the data collection system 1. This processing is realized by the processor 112 shown in FIG. 2, the processor 212 shown in FIG. 3A and the processor 312 shown in FIG. 3B, each of which execute a program prepared in advance and operates as the elements shown in FIG. 4.

First, the user inputs the user information to the user terminal 200. The user information input unit 421 of the user terminal 200 acquires the user information and transmits the information to the server 100 (step S11). The information acquisition unit 411 of the server 100 acquires the user information from the user terminal 200 (step S12), and stores the user information in the user DB 412. The R&D worker inputs the project information to the R&D terminals 300. The project information input unit 431 of the R&D terminal 300 acquires the project information and transmits the received project information to the server 100 (step S13). The information acquisition unit 411 of the server 100 acquires the project information from the R&D terminal 300 (step S14), and stores it in the project DB 413.

Next, the information output unit 414 of the server 100 extracts the project information of the project that satisfies the predetermined conditions from the project DB 413 and generates the project list. The information output unit 414 transmits the project list to the user terminal 200 (step S15). An example of the predetermined condition is that the project is within the application period.

The project display unit 422 of the user terminal 200 acquires the project list from the server 100 and displays the project list on the screen (step S16). The user operates the user terminal 200 to select a desired project to participate from one or more projects included in the project list. The desired project input unit 423 of the user terminal 200 transmits the project ID of the desired project selected by the user and the user ID to the server 100 (step S17).

The project application acquisition unit 415 of the server 100 acquires the project ID of the desired project and the user ID from the user terminal 200 and outputs them to the project establishment determination unit 416. The project establishment determination unit unit 416 acquires the project ID of the desired project and the user ID from the project application acquisition unit 415. Then, the project establishment determination unit 416 determines whether or not the project is established (step S18). Specifically, the project establishment determination unit 416 extracts the participation conditions of the objective project from the project DB 413 based on the project ID of the desired project. Also, the project establishment determination unit 416 extracts the user information of the objective user from the user DB 412 based on the user ID. Then, the project establishment determination unit 416 compares the participation conditions of the project with the user information, and determines whether or not the user satisfies the participation conditions of the project. If the user satisfies the participation conditions of the project, the project establishment determination unit 416 accepts the user's application and updates the number of applicants in the project DB 413. Then, the project establishment determination unit 416 determines whether or not the project is established, based on the number of recruited persons and the number of applicants of the project. If the number of applicants for the project reaches the number of recruited persons, the project establishment determination unit 416 determines that the objective project is established (step S18: Yes), and transmits the project established notification to the user terminal 200 and the R&D terminal 300 (step S19).

On the other hand, if the number of applicants for the project does not reach the number of recruited persons, the project establishment determination unit 416 determines that the objective project is under determination (step S18: No). Then, the processing returns to step S15, and continues. If the number of applicants for the project does not reach the number of recruited persons even after the recruiting period has elapsed, the project establishment determination unit 416 determines that the objective project is not established and terminates the recruiting for the project. At this time, the project establishment determination unit 416 may transmit the project unestablished notification to the user terminal 200 and the R&D terminal 300.

The user terminal 200 receives the project established notification from the server 100. The determination result display unit 425 of the user terminal 200 displays the content of the notification on the screen of the user terminal 200 (step S20). The R&D terminal 300 receives the project established notification from the server 100. Then, the determination result display unit 432 of the R&D terminal 300 displays the content of the notification on the screen of the R&D terminal 300 (step S21).

When the service is completed (step S22: Yes), the R&D worker inputs the completed service information to the R&D terminal 300 as the project completion information. The project completion information input unit 433 of the R&D terminal 300 acquires the completed service information and transmits the information to the server 100 (step S23). The project completion information acquisition unit 418 of the server 100 acquires the completed service information (step S24). The project completion information acquisition unit 418 outputs the completed service information to the project completion notification unit 420 of the server 100. The project completion notification unit 420 generates the service completion notification as the project completion notification based on the completed service information acquired from the project completion information acquisition unit 418 and transmits it to the user terminal 200 (step S25). The project completion notification display unit 426 of the user terminal 200 acquires the service completion notification from the server 100 and displays it on the screen (step S26). The service completion notification may also include procedures for using the completed service, etc. This allows the user to use the completed service.

On the other hand, when the service is not completed (step S22: No), the R&D worker inputs the project termination report in the R&D terminal 300 as the project completion information. The project completion information input unit 433 of the R&D terminal 300 acquires the project termination report and transmits it to the server 100 (step S27). The project completion information acquisition unit 418 of the server 100 acquires the project termination report (step S28). The project completion information acquisition unit 418 outputs the project termination report to the project completion notification unit 420 of the server 100. The project completion notification unit 420 generates the project termination notification as the project completion notification based on the project termination report acquired from the project completion information acquisition unit 418, and transmits the project termination notification to the user terminal 200 (step S29). The project termination notification may include information of recommended projects. The project completion notification display unit 426 of the user terminal 200 acquires the project termination notification from the server 100 and displays it on the screen (step S30).

[Modification]

Next, a modification of the first example embodiment will be described. The following modifications can be applied to the first example embodiment in appropriate combination.

(Modification 1)

The server 100 may predict project themes with demand from the past project information and present them to the R&D workers. For example, the server 100 performs demand prediction for each project theme using a prediction model that is learned in advance. The prediction model is a model that has already been learned based on the project themes and the past project information (such as the establishment status of the project and the final number of applicants). The server 100 uses the prediction model to predict demand for each project theme and presents the demand prediction results to the R&D workers. This enables the R&D workers to grasp the demand trends for each project theme and determine themes for new projects based on the demand trends.

(Modification 2)

In the above-described first example embodiment, the R&D workers determine the number of points (incentives) to be given to the user. However, the server 100 may predict the appropriate amount of incentive using a previously learned prediction model or the like and present it to the R&D workers. The prediction model is learned in advance based on a large number of project information in the past (e.g., information such as the project themes, the collected data, the project establishment status, the incentives, etc.). When the R&D worker registers the project information to the server 100 through the R&D terminal 300, the server 100 predicts the incentive from the registered project information using the prediction model. The server 100 transmits the prediction result to the R&D terminal 300. This allows R&D workers to figure out how much incentive is needed to establish the project.

### Second Example Embodiment

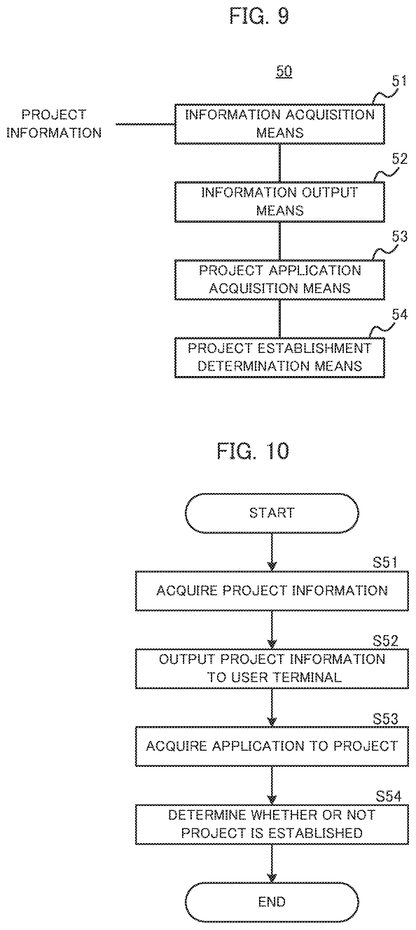

FIG. 9 is a block diagram illustrating a functional configuration of an information processing device according to a second example embodiment. The information processing device 50 includes an information acquisition means 51, an information output means 52, a project application acquisition means 53, and a project establishment determination means 54.

FIG. 10 is a flowchart of processing executed by the information processing device according to the second example embodiment. The information acquisition means 51 acquires project information inputted by an R&D worker (step S51). The information output means 52 outputs the project information to a user terminal (step S52). The project application acquisition means 53 acquires applications for a project inputted by a plurality of user terminals (step S53). The project establishment determination means 54 determines whether or not the project is established, based on the applications for the project (step S54).

According to the information processing device of the second example embodiment, it is possible to continuously collect the data of the research target person.

A part or all of the above example embodiments may also be described as the following Supplementary notes, but are not limited thereto.

(Supplementary Note 1)

An information processing device comprising:

an information acquisition means configured to acquire project information inputted by an R&D worker;

an information output means configured to output the project information to a user terminal;

a project application acquisition means configured to acquire applications for a project inputted by a plurality of user terminals; and

a project establishment determination means configured to determine whether or not the project is established, based on the applications for the project.

(Supplementary Note 2)

The information processing device according to claim 1, wherein the project establishment determination means determines whether or not the project is established, based on a number of the applications for the project.

(Supplementary Note 3)

The information processing device according to claim 1, wherein the project establishment determination means determines whether or not the project is established, based on human attributes of the user and a number of the applications for the project.

(Supplementary Note 4)

The information processing device according to claim 1, wherein the information output means outputs a number of the applications for the project at a present time.

(Supplementary Note 5)

The information processing device according to claim 1, wherein the project establishment determination means gives predetermined points determined in advance for each project to the user who participates in the project, when the project is established.

(Supplementary Note 6)

The information processing device according to claim 1, wherein the project establishment determination means proposes participation in another project when the project is not established.

(Supplementary Note 7)

An information processing method comprising:

acquiring project information inputted by an R&D worker;

outputting the project information to a user terminal;

acquiring applications for a project inputted by a plurality of user terminals; and

determining whether or not the project is established, based on the applications for the project.

(Supplementary Note 8)

A recording medium recording a program, the program causing a computer to:

acquire project information inputted by an R&D worker;

output the project information to a user terminal;

acquire applications for a project inputted by a plurality of user terminals; and

determine whether or not the project is established, based on the applications for the project.

While the present disclosure has been described with reference to the example embodiments and examples, the present disclosure is not limited to the above example embodiments and examples. Various changes which can be understood by those skilled in the art within the scope of the present disclosure can be made in the configuration and details of the present disclosure.

This application is based upon and claims the benefit of priority from Japanese Patent Application 2022-096964, filed on Jun. 16, 2022, the disclosure of which is incorporated herein in its entirety by reference.

### DESCRIPTION OF SYMBOLS

1 Data collection system
100 Server
200 User terminal
300 R&D terminal
411 Information acquisition unit
412 User DB
413 Project DB
414 Information output unit
415 Project application acquisition unit
416 Project establishment determination unit
417 Determination result DB
418 Project completion information acquisition unit
419 Completed service DB
420 Project completion notification unit
421 User information input unit
422 Project display unit
423 Desired project input unit
424 Number-of-applicants display unit
425 Determination result display unit
426 Project completion notification display unit
431 Project information input unit
432 Determination result display unit
433 Project completion information input unit

1. An information processing device comprising:
a memory configured to store instructions; and
one or more processors configured to execute the instructions to:
acquire project information inputted by an R&D worker;
output the project information to a user terminal;
acquire applications for a project inputted by a plurality of user terminals; and
determine whether or not the project is established, based on the applications for the project.

2. The information processing device according to claim 1, wherein the one or more processors determine whether or not the project is established, based on a number of the applications for the project.

3. The information processing device according to claim 1, wherein the one or more processors determine whether or not the project is established, based on human attributes of the user and a number of the applications for the project.

4. The information processing device according to claim 1, wherein the one or more processors output a number of the applications for the project at a present time.

5. The information processing device according to claim 1, wherein the one or more processors give predetermined points determined in advance for each project to the user who participates in the project, when the project is established.

6. The information processing device according to claim 1, wherein the one or more processors propose participation in another project when the project is not established.

7. An information processing method comprising:
acquiring project information inputted by an R&D worker;
outputting the project information to a user terminal;
acquiring applications for a project inputted by a plurality of user terminals; and
determining whether or not the project is established, based on the applications for the project.

8. A non-transitory computer-readable recording medium recording a program, the program causing a computer to:
acquire project information inputted by an R&D worker;
output the project information to a user terminal;
acquire applications for a project inputted by a plurality of user terminals; and
determine whether or not the project is established, based on the applications for the project.
